(19) United States
(12) Patent Application Publication
(10) Pub. No.: US 2025/0358124 A1
(43) Pub. Date: Nov. 20, 2025

(54) ZERO KNOWLEDGE COOKIE

(71) Applicant: Risc Zero, Inc., Seattle, WA (US)

(72) Inventors: Jeremy Bruestle, Seattle, WA (US); Frank Laub, Seattle, WA (US); Tim Carstens, Seattle, WA (US)

(21) Appl. No.: 19/213,827

(22) Filed: May 20, 2025

Related U.S. Application Data
(60) Provisional application No. 63/649,878, filed on May 20, 2024.

(51) Int. Cl. H04L 9/32

(52) U.S. Cl. CPC H04L 9/3221

(57) ABSTRACT

Methods and systems related to secure interactions between users and cloud platforms without compromising user and data privacy are disclosed herein. A user device is configured to generate and store a zero-knowledge cookie (zkCookie). A cloud platform is configured to validate user queries using a zero-knowledge proof derived from the zkCookie, where the cloud platform is restricted from identifying a user or determining whether multiple queries originate from the same user.

### CROSS REFERENCE TO RELATED APPLICATION

This application claims the benefit of U.S. Provisional Patent Application No. 63/649,848, titled “Zero Knowledge Cookie,” and filed on May 20, 2024, the entire content of which is incorporated by reference herein.

### TECHNICAL FIELD

This disclosure relates to cloud data analytics, in particular, to secure interactions between users and cloud platforms without compromising user and data privacy.

### BACKGROUND

The growth in cloud is explosive, and data analytics today is rapidly moving to cloud platforms. These cloud platforms and data analytics tools can be applied to help users to identify patterns, make predictions, and derive intelligent insights, etc. Some of these tools/platforms have been built to be powerful, intuitive, and easy to use, which significantly benefits regular users, but, conversely, also increases the chance that bad actors strike and sabotage the cloud environment. A variety of approaches have been developed to mitigate potential damages that may be caused by such strikes; however, these approaches are often complicate, hard to implement, and problematic regarding the data/user privacy.

### SUMMARY

To address the aforementioned shortcomings, methods and systems related to secure interactions between users and cloud platforms without compromising user and data privacy are disclosed herein. A user device is configured to generate and store a zero-knowledge cookie (zkCookie). A cloud platform is configured to validate user queries using a zero-knowledge proof derived from the zkCookie, where the cloud platform is restricted from identifying a user or determining whether multiple queries originate from the same user.

In some embodiments, the system further comprises a zero-knowledge virtual machine (zkVM) guest executed on the user device. The zkVM guest is configured to manage a state machine associated with the zkCookie. All user interactions with the zkCookie are mediated through the zkVM guest to ensure integrity and compliance with cloud platform policies. In some embodiments, the state machine indicates that the zkCookie is associated with the user. In some embodiments, the state machine includes one or more of a timestamp, a nonce, and arbitrary internal data.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 illustrates an exemplary block diagram of high-level user interactions between a user and a cloud platform, according to some embodiments.

FIG. 2 illustrates exemplary modules of a zero knowledge cookie component provided by the disclosed system, according to some embodiments.

FIG. 3 illustrates an exemplary flowchart of authenticating a user session with a cloud platform without revealing an identity of a user, according to some embodiments.

FIG. 4 illustrates a block diagram of an example computer system that may be used in implementing the technology described herein, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Technical Challenges

Cloud data analytics tools are designed to analyze data and obtain actionable insights effortlessly for informed decision making. In a typical interaction of data analytics, a user may log into a cloud platform, submit a query for a specific task, receive a response from executing the specific task, submit another query for another task, receive another response from executing the other task, etc., until the user has all the tasks implemented within his/her session. Because the cloud platforms and data analytics are built to be powerful and user-friendly, bad actors occasionally may use these tools/platforms to commit cybercrime or cause other damages.

Some cloud systems address this problem by using backend models that can identify and classify queries as benign or harmful. This allows harmful queries to be blocked and further provides the ability to deny access of the users who submit the harmful queries. However, this approach has some downsides, as it creates vulnerabilities and interdependencies between the threats of both data privacy and security.

Specifically, the current approach requires the cloud platforms to track and possess personal information such as which user submitted which query. This may be used to stop the unauthorized access from intruders to the data stored in cloud platforms. But this may become unintended inferences that threaten the anonymity of honest users and reveal sensitive information of the honest users, thereby working against the privacy needs of honest users. The concern with protecting personal data may also increase regulatory burden around data privacy. Moreover, this approach may complicate the technical design because of the difficulties in configuring and describing relationships among different parties.

An approach that can continue to combat harmful usage of cloud platforms and data analytics tools without compromising the privacy of honest users is therefore desirable.

### System Overview

The disclosed system and method impose certain restraints on cloud platforms (e.g., Acme® cloud) while allowing the platforms to moderate the usage of cloud analytics service. That is, the present approach may allow the platforms to reject queries, impose rate limits, and ban users, etc., but disallow the platforms to track and identify the user who submitted a specific query, determine whether two queries were submitted by the same user, etc. While some example restraints are described herein, it should be noted that the present approach may be able to impose other restraints.

Described herein is a mechanism that uses on-device storage, together with zero-knowledge proofs (ZKP), to solve the foregoing problems securely and privately. Using ZKP, a first party can prove to a second party that a given assertion is true, when the first party conveys only the asserted fact that the information is indeed true without revealing the information itself or any additional information.

In some embodiments, the disclosed system uses a special cookie to add security and privacy protection to interactions between a user and a cloud platform. This cookie, referred to as zkCookie, is a piece of data that is resided on a user device (e.g., mobile device, desktop computer) associated with a user and managed by a remote endpoint. In some embodiments, the remote endpoint may be a cloud platform that includes a variety of applications (e.g., software applications) that perform data analytic operations requested by the user. Unlike traditional cookies, (1) this zkCookie is held by the user device and does not leave the user device, and (2) the remote endpoint or cloud platform has no ability to learn or know the content of the zkCookie. Rather, the present approach may allow the cloud platform's application to use ZKP to prove that the state of the cookie has certain properties without revealing this state. In some embodiments, one of these properties used in the disclosed system is configured to be “the state has only been updated in ways that are permitted by a specific cloud.” In this way, the exact content of the zkCookie is not revealed to the cloud platform but the cookie state (e.g., being associated with a specific cloud) can still be verified.

A critical portion of the disclosed system is cloud-zk-cookie, which is a zero knowledge virtual machine (zkVM) guest that runs on the user device associated with a user. A zkVM guest is a virtual machine that runs trusted code and generates proofs that authenticate an zkVM output. The zkVM guest includes the software component of a zkVM and is implemented to perform the functionalities as described herein. In some embodiments, the zkVM guest or cloud-zk-cookie may implement a state machine. An example state includes:
struct ClientState {
   time: DateTime//Last time from server
   nonce: U128//Random 128 bit nonce
   inner: <Whatever>//Arbitrary data
}

The state machine represents the zkCookie associated with a user. All interactions with the cookie are mediated by the zkVM guest. In some embodiments, the disclosed system may provide two entrypoints. The first entrypoint may be provided for creating a new zero-knowledge cookie, and the second entrypoint may be used for updating the state of an existing zero-knowledge cookie. The entrypoints and related operations can be used during a query flow as described below.

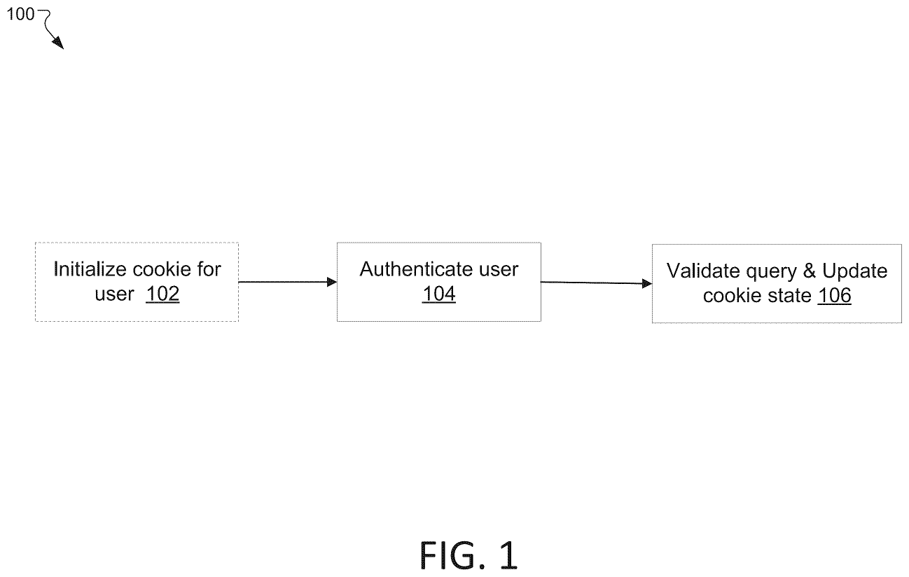

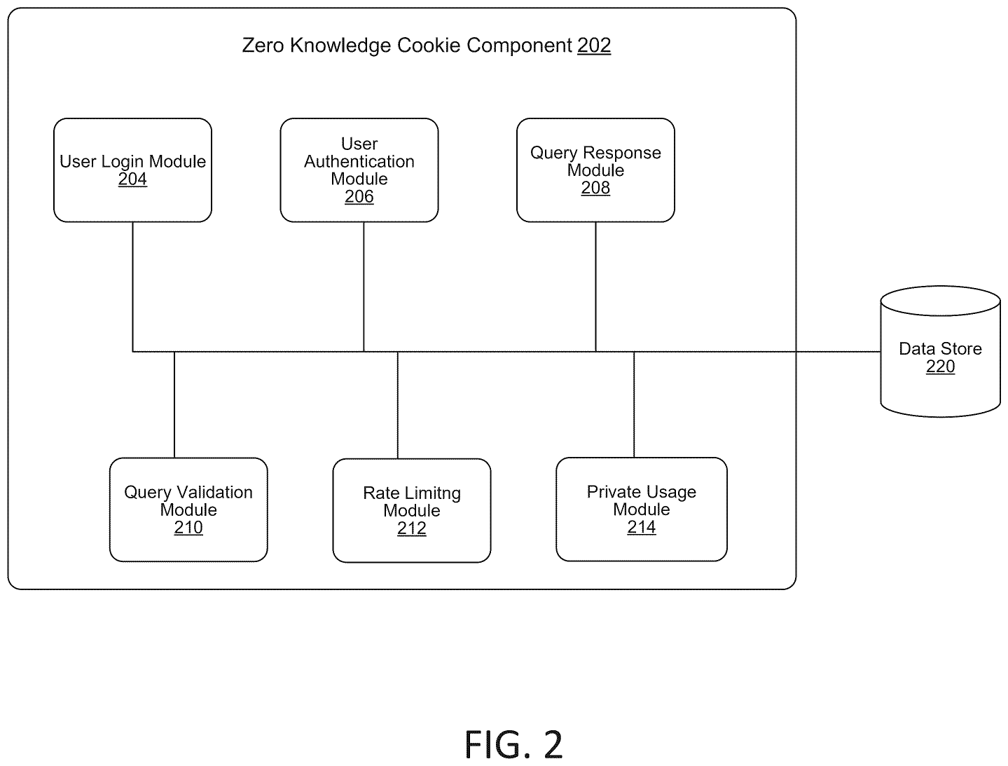

FIG. 1 illustrates an exemplary block diagram 100 of high-level user interactions between a user and a cloud platform. In some embodiments, the disclosed system may include a zero knowledge cookie component, which will be described below in FIG. 2, to establish the communication with a cloud platform. This zero knowledge cookie component at least includes the zkVM guest or cloud-zk-cookie running on a user device associated with the user.

In some embodiments, the disclosed system may apply an anonymizing transport layer such as oblivious hypertext transfer protocol (OHTTP). In a typical interaction between a user and a cloud platform, the disclosed system allows an application of a cloud system to initialize a cookie for a user at 102, authenticate the user at 104, and validate a user query and update the state of the cookie at 106.

First, the user may launch the cloud platform's application on his/her user device, sign in the application, and request an anonymous session. In response, the disclosed system may enable the application, and the cloud platform to perform a handshake. Once the handshake is complete, the application may use the cloud-zk-cookie to initialize a new zkCookie at 102. This step is optional (as indicated by dashed-line) because it can be skipped if the user already has an unexpired zkCookie.

Based on a valid zkCookie (e.g., initialized cookie or unexpired cookie), the disclosed system may allow the user to enter a privacy mode. In this mode, the disclosed system may allow the application to forget the user's credentials and, instead, use the zkCookie to authenticate itself to the cloud platform. Therefore the user is authenticated at 104.

The disclosed system now allows the user to submit a query to the cloud platform. In some embodiments, this query includes a ZK proof about the current state of the user's zkCookie. The cloud platform may then use the zkCookie to validate the user query or user session without identifying the user at 106. Responsive to this validation, the cloud platform may respond the query with the requested data, along with a signed message. The disclosed system may use the application to transmit this signed message to the cloud-zk-cookie. The cloud-zk-cookie or zkVM guest may further use the signed message to update the state of the zkCookie associated with the user at 106.

The disclosed system introduces a novel approach to privacy-preserving authentication and session management in cloud computing environments by leveraging ZKPs and on-device state management through zkCookies. One technical benefit of this system is its ability to authenticate user queries and enforce platform-level usage constraints (such as rate limiting, abuse prevention, or banning) without requiring the cloud platform to track user identities. This eliminates the need to associate requests with specific users, thereby preventing identity linkage, tracking, or profiling. At the same time, the disclosed system retains the ability to verify that requests are compliant with platform policies through cryptographically sound proofs generated by the zkVM guest on the user device. This combination of strong user privacy with robust enforcement capabilities directly addresses a long-standing tradeoff in the field of cloud analytics and secure service delivery.

Another important advancement offered by the disclosed system is the decentralization of session and configuration state. Unlike conventional systems where user-related session data resides in a centralized backend, zkCookies are stored entirely on the user device. The zkVM ensures that only authenticated and valid transitions are made to the state of the zkCookie, and the resulting zero-knowledge proofs are the only data exchanged with the cloud. This architecture not only enhances data minimization and user control but also greatly reduces the attack surface associated with centralized user data storage. Additionally, zkCookies are non-linkable across queries, preventing the cloud platform to determine whether two requests originated from the same user. This is particularly important in compliance with data protection laws.

Further improving security and trust, the disclosed system employs a zkVM guest to mediate all interactions with the zkCookie. The zkVM runs trusted code on the user device and ensures that the proof of a given cookie state transition is both correct and policy-compliant. This guarantees the integrity of state updates without exposing the underlying state or user behavior to the cloud provider. Moreover, the disclosed system is designed to interoperate with anonymizing transport layers, which prevents even network-layer metadata from revealing identifying information.

Overall, the disclosed herein enables a robust privacy-preserving authentication framework where the user retains control over their identity and data, while the cloud platforms retain the ability to maintain service integrity and security. This architecture significantly advances the field by shifting the paradigm from cloud-centric identity management to user-centric, proof-based interaction.

### Zero Knowledge Cookie Component

FIG. 2 illustrates exemplary modules of zero knowledge cookie component 202 provided by the disclosed system. This component in combination with other computer systems (e.g., cloud platforms) may perform the functionalities described herein, including the interaction flow shown in FIG. 1. In some embodiments, zero knowledge cookie component 202 may include a zkVM guest that runs on the user device associated with a user.

As illustrated, zero knowledge cookie component 202 includes a user login module 204, a user authentication module 206, a query response module 208, a query validation module 210, a rate limiting module 212, and a private usage module 214. In some embodiments, zero knowledge cookie component 202 may include only a subset of the aforementioned modules or include at least one of the aforementioned modules. Additional modules may be present on other communicatively coupled computer systems such as a server (not shown). All possible permutations and combinations, including the ones described above, are within the spirit and the scope of this disclosure.

In some embodiments, each module of zero knowledge cookie component 202 may store the data used and generated in performing the functionalities described herein in data store 220. Data store 220 may be resided in a server and categorized in different libraries (not shown). Each library stores one or more types of data used in implementing the methods described herein. By way of example and not limitation, each library can be a hard disk drive (HDD), a solid-state drive (SSD), a memory bank, or another suitable storage medium to which various entities (e.g., user device, server) have read and write access.

### User Login and Authentication

User login module 204 of zero knowledge cookie component 202 may receive and process a user's login request to an application of a cloud platform. The application may perform data analytics tasks requested by the user (e.g., in the form of query) and return corresponding responses to the user. An example login flow is shown below:

| struct LoginRequest { | |
|---|---|
| nonceCommit: Digest // Hash of nonce | |
| details: <Whatever login request data> | |
| } | |
| struct LoginResponse { | |
| nonceCommit: Digest // Hash of nonce | |
| time: DateTime | // Current server time |
| details: <Whatever Login response data> | |
| signature: PKSig | // Signature of above |

}

A user launches an application of the cloud system on his/her user device and signs into his/her account associated with the cloud system, which causes a login request to be sent to the application. In response to receiving this login request, the user login module 204 instructs the application to generate a random nonce (e.g., random 128-bit value nonce) and send a nonceCommit=Hash (nonce) to the cloud platform, together with the login credentials of the user, as indicated in the above login flow.

Based on the information received from the user login module 204, user authentication module 206 may determine whether to verify the user and grant the user access to the cloud platform. In some embodiments, user authentication module 206 may validate the user's login credentials. User authentication module 206 may also determine if the user has requested a session recently, that is, if the user may have another active zkCookie. If yes, user authentication module 206 may deny the pending login request from the user for rate-limiting protection. Otherwise, user authentication module 206 may communicate with other modules (e.g., query response module 208, query validation module 210) to respond to the request, for example, by sending a LoginResponse as shown above in the example login flow. In some embodiments, this response may include a signed copy of the user's nonceCommit and a timestamp from the cloud server.

In some embodiments, user authentication module 206 may also update the records to indicate that the user created a session at the DateTime indicated above in the example login flow. In some embodiments, user authentication module 206 also signals the cloud platform's application to save the signed response for future use by cloud-zk-cookie.

### Cloud-Zk-Cookie Guest

A cloud-zk-cookie guest is a zkVM guest that mediates all interactions between a user and a cloud platform using the user's zkCookie. In some embodiments, this guest provides two functions: init ( ) and update ( ) As the names suggest, init ( ) is used to create a new ClientState, while update ( ) is used to update an existing ClientState. Pseudocode for these functions can be seen below:

```
fn init(
  nonce: U128,
  response: LoginResponse,
  clientTime: DateTime
) −> ClientJournal
{
  verify_signature(response);
  state := ClientState {
    time : response.time,
    nonce : nonce,
    inner : F(response.details),
  }
  assert Hash(nonce) == response.nonceCommit;
  assert clientTime >= response.time;
  assert clientTime − response.time < IDLE_TIMEOUT
  return ClientJournal {
    stateDigest: Hash(state),
    time: clientTime,
    public: SomeFunction(state)
  }
}
fn update(
  oldState: ClientState,
  response: TxnResponse,
  clientTime: DateTime
) −> ClientJournal
{
  verify_signature(response);
  assert Hash(oldState) == response.prevStateDigest
  newState := ClientState {
    time : response.time,
    nonce : oldState.nonce,
    inner : SomeUpdateFunction(
        oldState.inner,
        response.details
      ),
  }
  assert clientTime >= response.time;
  assert response.time >= oldState.time;
  assert clientTime − oldState.time < IDLE_TIMEOUT;
  return ClientJournal {
    stateDigest: Hash(newState),
    time: clientTime,
    public: SomeFunction(newState),
  }
}
```

### Query Validation and Response

Referring back to FIG. 2, once user authentication module 206 verifies or authenticates the user, the application can enter a privacy mode. In this mode, the application can ignore or forget the user's credentials. Therefore, by forgetting the credentials, the disclosed system allows the application to use zkCookies to anonymously authenticate subsequent queries. An example flow for submitting a query is shown below:

| struct ClientJournal { | |
|---|---|
| stateDigest: Digest | // Hash of ClientState |
| time: DateTime | // Current client time |
| public: <Any public view of state to send server> | |
| } | |
| struct TxnRequest { | |
| journal: ClientJournal | |
| proof: ZKP commiting to Journal | |
| details: <Whatever request data> | |
| } | |
| struct TxnResponse { | |
| prevStateDigest: Digest // Copy of request.journal.stateDigest | |
| time: DateTime | // Current server time |
| details: <Whatever response data> | |
| signature: PKSig. | // Signature of above |

}

At this point, a user has launched the cloud system's application on his/her user device, and a ZK session associated with the application has been initiated, the user can start to submit queries immediately. The query response module 208 of zero knowledge cookie component 202 may receive the query submitted by the user and communicate with the cloud platform's application to respond to the query.

In some embodiments, query response module 208 may allow the application to use the last saved response from the cloud to generate a ZK proof. There are two cases. In the first case where the received query is the first query made under this session, the application may invoke the init ( ) function provided by cloud-zk-cookie guest. In the second case where the received query is not the first query, the application may invoke the update ( ) function provided by the cloud-zk-cookie guest.

In both cases, query response module 208 may instruct the application to supply the last saved response from the cloud, together with the current time. In some embodiments, the current time may be determined from the user device. The query response module 208 may then use the cloud-zk-cookie guest to compare the current time to the signed time provided by the server in its last response. If a specified threshold time period has elapsed, the guest may abort without generating a proof. However, if the guest succeeds in generating a proof, the application may obtain two pieces of data from the guest.

In some embodiments, the two pieces of data are (1) a clientJournal together with a ZK proof and (2) a ClientState. It should be noted that the combination of clientJournal and ZK proof does not contain any user-identifying information and thus can be shared with the cloud platform without invading user privacy. As to the ClientState, this data remains on the user device. Only the hash of this state is used as a single-use token when authenticating queries.

As indicated in the above query flow, the query response module 208 may then notify the application to send a TxnRequest to the cloud platform. This request may include the user's query, as well as the aforementioned ClientJournal and ZK proof.

Upon receiving the TxnRequest, query validation module 210 may communicate with the cloud service to validate the session and the query. In some embodiments, query validation module 210 may allow the cloud service to first check if the request.journal.time associated with the TxnRequest is relatively recent. For example, query validation module 210 may determine if this journal time is within the allowable drift for two clocks on the Internet. If the time is outside the specified window, query validation module 210 may determine that the session is expired and reject the query. As a result, the user must create a new ZK session to get a response for his/her query. This check is particularly advantageous because it prevents the user from supplying maliciously-skewed time data into cloud-zk-cookie.

On the other hand, if the first request.journal.time check shows that the request is within the specified window, the query validation module 210 may allow the cloud service to perform the second check on the ZK proof to validate the provenance of the session metadata, i.e. to ensure that the data really did come from the cloud-zk-cookie. If the proof is invalid, the query validation module 210 may reject the query.

In some embodiments, the cloud service may further check to see if it has received the request.journal.stateDigest before. If so, the query is rejected. In effect, this means stateDigest is a one-time use token. While this further check with previous stateDigest requires storing a set of recently-seen stateDigest values in a database (e.g., in the cloud platform), it should be noted that the first request.journal.time check (to see whether the query is relatively recent) together with session timeout login in cloud-zk-cookie, indicates that values do not need to be permanently stored in the database. Instead, these data can be purged once their respective expiration dates are reached.

In response to the successful checks shown above, the query validation module 210 along with the cloud service may then add the request.journal.stateDigest to the set of recently-seen states. This prevents the user from being able to submit future queries based on this state. By induction, this means the user cannot reuse any previous states.

Once the query/session gets validated, the query validation module 210 may communicate with the query response module 208 to determine whether to execute the query and send a response to the requesting user. In some embodiments, query response module 208 may allow the cloud service to employ one or more abuse models to determine if the query is harmful. If the received query is harmful, the query gets rejected. At this point the user's ZK session is effectively terminated. This means that the user's current and previous session states cannot be reused because the stateDigest is a one-time token and the state is also not stored in the database as one of the set of recently-seen states. In addition, users may not have the ability to create a new state for themselves, since the state is only considered valid if accompanied by a ZK proof from cloud-zk-cookie, which in turn requires a new signed response from the cloud platform/service.

Eventually, if the check with the abuse models also succeeds, the query response module 208 may allow the cloud service to run this query and respond with a TxnResponse to the user. The cloud platform's application may then save the signed response for future use by cloud-zk-cookie.

### Extended Protection

The zkCookie approach described herein may be applied for extended protection, for example, based on tracking additional metrics or state on the user device. The extended protection may also relate to implementation of additional policies on query submission. In some embodiments, this is achieved through the details fields in the structures above, together with the SomeFunction ( ) and SomeUpdateFunction ( ) stubs in the pseudocode description of cloud-zk-cookie. As depicted in FIG. 2, zero knowledge cookie component 202 also includes rate limiting module 212 and private usage module 214 to achieve the extended protection. It should be noted these are merely example extended use cases of the zkCookie approach described herein, there are other extended uses within the spirit and the scope of this disclosure.

### Rate Limiting

In some embodiments, rate limiting module 212 may be applied to implement rate limiting for queries. As shown in the above login flow and query flow, the LoginResponse and TxnResponse both contain signed timestamps provided by the cloud platform. In the pseudocode given above, these timestamps are used to implement the session-timeout functionality, for example, by requiring that the client's current time is within the IDLE_TIMEOUT window.

To perform the extended protection of rate limiting, rate limiting module 212 may augment ClientState with a buffer of recently seen timestamps. The rate limiting module 212 may then call SomeFunction ( ) stub to use that buffer to determine whether the user is exceeding the rate limit for queries. If so, the function aborts, and the rate limiting module 212 prevents the user from obtaining the necessary ZK proof until a future time when they are back within the allowed rate. With this approach, the disclosed system can enjoy the benefits of rate limiting without implementing session tracking in cloud platforms.

### Differentially-Private Usage Metrics

In some embodiments, the private usage module 214 may be applied to support differentially-private usage metrics. Differential privacy is a client-side privacy enhancing technology that allows service providers to gather aggregate usage statistics without revealing information about any particular user. At a high level, it works by first calculating the relevant statistics on the user device and then adding an appropriate amount of noise before uploading the results to a cloud platform.

The private usage module 214 may use the zkVM guest to leverage differential privacy to track and anonymize metrics about the queries made within that session. In some embodiments, the private usage module 214 allows the SomeFunction ( ) to add noise to those metrics and report the results back to the cloud as part of the ClientJournal. In some embodiments, the reporting occurs when the noise signal reaches a specified threshold. With this approach, the disclosed system can make certain that the metrics reflect the totality of the session (i.e. the user cannot selectively decide which queries get reflected in the metrics), even though the metrics and/or anonymizing noise were computed entirely on the user device.

### Flow Chart

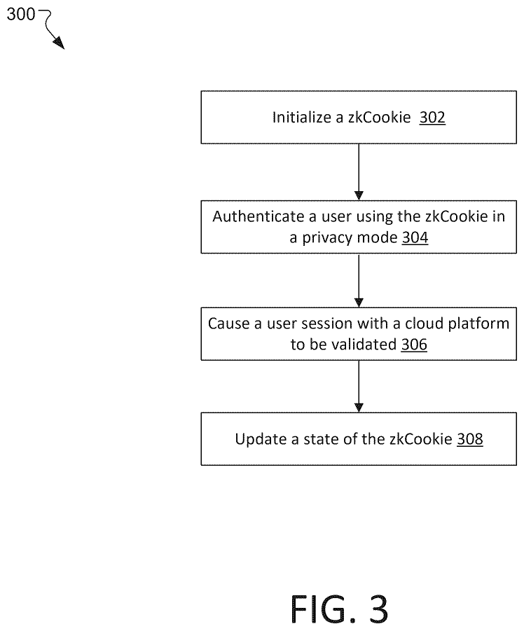

FIG. 3 illustrates an exemplary flowchart 300 of authenticating a user session with a cloud platform without revealing an identity of a user, according to some embodiments. In some embodiments, various components of zero knowledge cookie component 202 associated with a user device along with other system components (e.g., a cloud server) may work together to implement the operations of flowchart 300.

At step 302, a zkCookie is initialized. A zkCookie can be used to authenticate a user accessing an application without revealing user's identity, where the application is provided by a cloud platform. In some embodiments, initializing the zkCookie comprises creating a new zkCookie or updating a state of an existing zkCookie.

At step 304, a user is authenticated using the zkCookie in a privacy mode. In this mode, the zero knowledge cookie component 202 may allow the application to forget the user's credentials and, instead, use the zkCookie to authenticate the user.

At step 306, a user session with the cloud platform is validated on the cloud platform based on the authentication of the user. For example, the user may submit a use query to request data from the cloud platform. The cloud platform can validate this user query without revealing the user identity and transmit the requested data back to the user.

At step 308, a state of the zkCookie is updated. In some embodiments, when the cloud platform returns the requested data back to the user associated with the user device, a signed message is also transmitted to the user device. The zkVM guest on the user device can use the signed message to update the zkCookie such that this cookie may be reused in future sessions with the cloud platform.

### Computer Implementation

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used, and/or functional programming languages can be used. Electrical memory, such as flash-based memory, can be used.

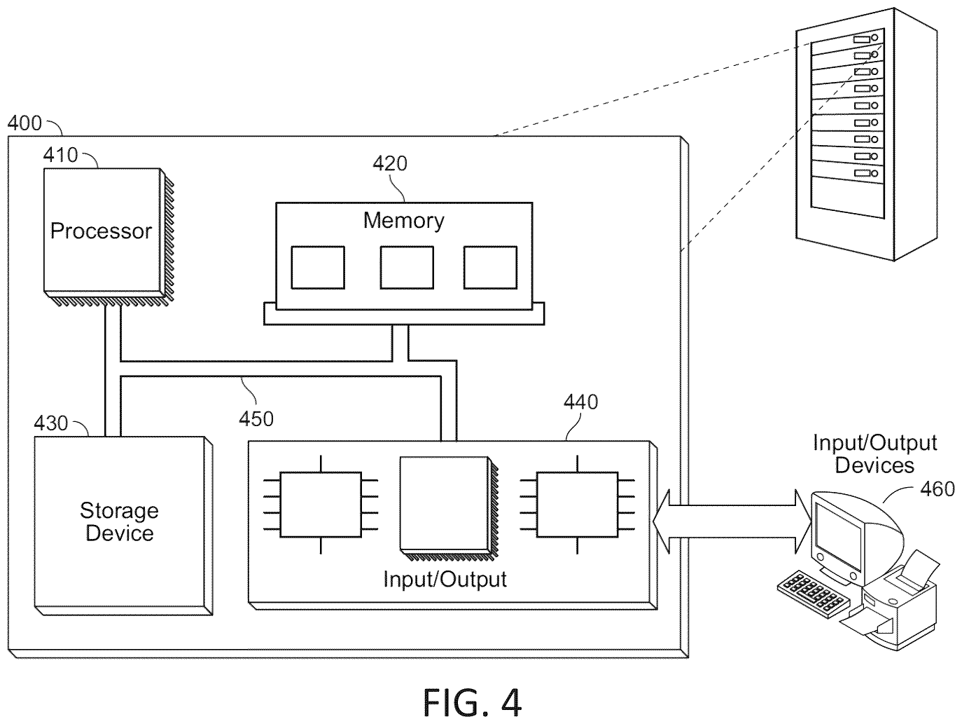

FIG. 4 is a block diagram of an example computer system 400 that may be used in implementing the technology described herein. General-purpose computers, network appliances, mobile devices, or other electronic systems may also include at least portions of the system 400. The system 400 includes a processor 410, a memory 420, a storage device 430, and an input/output device 440. Each of the components 410, 420, 430, and 440 may be interconnected, for example, using a system bus 450. The processor 410 is capable of processing instructions for execution within the system 400. In some implementations, the processor 410 is single-threaded. In some implementations, the processor 410 is a multi-threaded processor. The processor 410 is capable of processing instructions stored in the memory 420 or on the storage device 430.

Memory 420 stores information within the system 400. In some implementations, the memory 420 is a non-transitory computer-readable medium. In some implementations, the memory 420 is a volatile memory unit. In some implementations, the memory 420 is a non-volatile memory unit.

The storage device 430 is capable of providing mass storage for the system 400. In some implementations, the storage device 430 is a non-transitory computer-readable medium. In various implementations, the storage device 430 may include, for example, a hard disk device, an optical disk device, a solid-state drive, a flash drive, or some other large-capacity storage device. For example, the storage device may store long-term data (e.g., database data, file system data, etc.). The input/output device 440 provides input/output operations for the system 400. In some implementations, the input/output device 440 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer, and display devices 460. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, executable code, or other instructions stored in a non-transitory computer-readable medium. The storage device 430 may be implemented in a distributed way over a network, such as a server farm or a set of widely distributed servers, or may be implemented in a single computing device.

Although an example processing system has been described in FIG. 4, embodiments of the subject matter, functional operations, and processes described in this specification can be implemented in other types of digital electronic circuitry, in tangibly embodied computer software or firmware, in computer hardware, including the structures disclosed in this specification and their structural equivalents, or combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media, and memory devices, including way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes.

Accordingly, other implementations are within the scope of the following claims

### Terminology

The phraseology and terminology used herein are for the purpose of description and should not be regarded as limiting.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A system comprising:
a user device configured to generate and store a zero-knowledge cookie (zkCookie); and
a cloud platform configured to validate user queries using a zero-knowledge proof derived from the zkCookie,
wherein the cloud platform is restricted from identifying a user or determining whether multiple queries originate from the same user.

2. The system of claim 1, further comprising a zero-knowledge virtual machine (zkVM) guest executed on the user device, wherein the zkVM guest is configured to manage a state machine associated with the zkCookie.

3. The system of claim 2, wherein the state machine indicates that the zkCookie is associated with the user.

4. The system of claim 3, wherein the state machine includes one or more of a timestamp, a nonce, and arbitrary internal data.

5. The system of claim 2, wherein user interactions with the zkCookie are mediated through the zkVM guest to ensure integrity and compliance with cloud platform policies.

6. The system of claim 1, wherein the cloud platform is further configured to reject the user queries without identifying the user.

7. A method comprising:
initializing a zero-knowledge cookie (zkCookie) on a user device associated with a user;
authenticating, at the user device, a user using the zkCookie in a privacy mode;
causing a user session to be validated at the cloud platform without revealing an identity of the user; and
updating, by the user device, a state of the zkCookie using a signed message from the cloud platform.

8. The method of claim 7, wherein initializing the zkCookie comprises creating a new zkCookie or updating a state of an existing zkCookie.

9. The method of claim 8, wherein the zkCookie is initialized upon absence or expiration of a previous zkCookie.

10. The method of claim 8, wherein the zkCookie is initialized based on a handshake between the cloud platform and the user device.

11. The method of claim 7, further comprising validating the state of the zkCookie to confirm that the update is permitted by the cloud platform without disclosing an update history.

12. The method of claim 7, wherein content of the zkCookie remains hidden from the cloud platform.

13. A computer program product comprising a non-transitory computer readable medium having computer readable program code stored thereon, the computer readable program code configured to:
initialize a zero-knowledge cookie (zkCookie) associated with a user;
authenticate a cloud platform session using the zkCookie;
generate and transmit a zero-knowledge proof about a state of the zkCookie in response to a user query; and
update the zkCookie using a signed message from the cloud platform.

14. The computer program product of claim 13, wherein the computer program code is further configured to:
enforce constraints that prevent the cloud platform from tracking, identifying, or correlating the user query.

15. The computer program product of claim 13, wherein the zkCookie is initialized upon absence or expiration of a previous zkCookie.

16. The computer program product of claim 13, wherein the zkCookie is initialized based on a handshake between the cloud platform and the application.
